(19) United States
(12) Patent Application Publication
(10) Pub. No.: US 2013/0159679 A1
(43) Pub. Date: Jun. 20, 2013

(54) Providing Hint Register Storage For A Processor

(71) Applicants: James E. McCormick, JR., Fort Collins, CO (US); Dale Morris, Steamboat Springs, CO (US)

(72) Inventors: James E. McCormick, JR., Fort Collins, CO (US); Dale Morris, Steamboat Springs, CO (US)

(21) Appl. No.: 13/330,914

(22) Filed: Dec. 20, 2011

(51) Int. Cl. G06F 9/312

(52) U.S. Cl. 712/220; 712/E09.033; 712/E09.023

(57) ABSTRACT

In one embodiment, the present invention includes a method for receiving a data access instruction and obtaining an index into a data access hint register (DAHR) register file of a processor from the data access instruction, reading hint information from a register of the DAHR register file accessed using the index, and performing the data access instruction using the hint information. Other embodiments are described and claimed.

### BACKGROUND

Processors are implemented in a wide variety of computing devices, ranging from high end server computers to low end portable devices such as smartphones, netbook computers and so forth. In general, the processors all operate to execute instructions of a code stream to perform desired operations.

To effect operations on data, typically data is stored in general-purpose registers of the processor, which are storage locations within a core of the processor that can be identified as source or destination locations within the instructions. In general, there are a limited number of registers available in a processor. Oftentimes, a computer program can be optimized for a particular platform on which it executes. This optimization can take many forms and can include programmer or compiler-driven optimizations. One manner of optimization is to execute an instruction using hint information that can be provided with the instruction. However, the availability of hint sources for providing this hint information is relatively limited, which thus diminishes optimizations available via hint information.

### BRIEF DESCRIPTION OF THE DRAWINGS

FIG. 1 is a flow diagram of a method in accordance with an embodiment of the present invention.

FIG. 2 is a flow diagram of a method for using hint information in accordance with an embodiment of the present invention.

FIG. 3 is a flow diagram of a method for accessing a hint stack in accordance with an embodiment of the present invention.

FIGS. 4 and 5 are graphical illustrations of mechanisms for pushing hint values onto a hint stack and popping values from the hint stack in accordance with one embodiment of the present invention.

FIG. 6 is a block diagram of an example hint register format in accordance with an embodiment of the present invention.

FIG. 7 is a block diagram of a processor core in accordance with one embodiment of the present invention.

FIG. 8 is a block diagram of a system in accordance with an embodiment of the present invention.

### DETAILED DESCRIPTION

In various embodiments, hint information for use in connection with various instructions to be executed within a processor can be provided more efficiently using an independent set of registers that can store the hint information. This independent register file is referred to generically herein as a hint register file. Although the scope of the present invention is not limited this regard, embodiments of such hint registers described herein are with regard to so-called data access instructions and accordingly, the hint registers to be described herein are also referred to as data access hint registers (DAHRs). However, the scope of the present invention is not limited in this regard, and hint registers can be provided for storing hint information used for purposes other than data access instructions such as instruction fetch behaviors, branch prediction behaviors, instruction dispersal behaviors, replay behaviors, etc. In fact, embodiments can apply to many scenarios in which there is more than one way to do something and, depending on the scenario, sometimes one way performs better and sometimes another way performs better.

By way of an independent register file for storing hint information, indexing information can be encoded into at least certain instructions to enable access to the hint information during instruction execution. Such hint information obtained from the hint registers can be used by various logic within the processor to optimize execution using the hint information.

In addition to providing a hint register file, a backup storage such as a stack can be provided to store multiple sets of hint values such that these values for different sections of code can be maintained efficiently within the processor in a stack associated with the DAHRs. For purposes of discussion, this stack can be referred to as a hint or DAHR stack (also referred to as a DAHS) and may be independent of other stacks within a processor.

Embodiments also provide for correct operation for legacy code written for processors that do not support hint registers. That is, embodiments can provide mechanisms to enable limited hint information associated with legacy code to obtain appropriate hint values using the data stored in the hint registers. In addition, because it is recognized that the hint information stored in these registers and used during execution does not affect correctness of operation, but instead aids in efficiency or optimization of the code, embodiments need not maintain absolute correctness of the hint information.

In various embodiments software can refine precisely how the processor should respond to locality hints specified by various data access instructions such as load, store, semaphore and explicit prefetch (lfetch) instructions, via the DAHRs. In various embodiments, a locality hint specified in the instruction selects one of the DAHRs, which then provides the hint information for use in the memory access. In one embodiment there are eight DAHRs usable by load, store and lfetch instructions (DAHR[0-7]); while semaphore instructions and load and store instructions with address post increment can use only the first four of these (DAHR[0-3]).

Note that each register of the hint register file can include a plurality of fields, each of which is to store hint information of a given type. In many embodiments, each register of the hint register file can have the same fields, where each register stores potentially different hint values in the different fields as programmed during operation.

Thus each DAHR contains fields which provide the processor with various types of data access hints. When a DAHR has not been explicitly programmed by software, these data hint fields can be automatically set to default values that best implement the generic locality hints as shown in Table 1, further details of which are below.

TABLE 1

| | Default Data |
|---|---|
| DAHR | Access Hint Settings |
| 0 | Temporal, level 1 |
| 1 | Non-temporal, level 1 |
| 2 | Non-temporal, level 2 |
| 3 | Non-temporal, all levels |
| 4 | DAHR[4] default |
| 5 | DAHR[5] default |
| 6 | DAHR[6] default |
| 7 | DAHR[7] default |

In some embodiments, DAHRs are not saved and restored as part of process context via an operating system, but are ephemeral state. When DAHR state is lost due to a context switch, the DAHRs revert to the default values. DAHRs may also revert to default values upon execution of a branch call instruction.

Embodiments may also optionally automatically save and restore the DAHRs on branch calls and returns in the hint stack within the processor. In one embodiment each stack level can include eight elements corresponding to the eight DAHRs. The number of stack levels may be implementation-dependent. On a branch call (and, in some embodiments, on certain interrupts), the elements in the stack are pushed down one level (the elements in the bottom stack level are lost), the values in the DAHRs are copied into the elements in the top stack level, and then the DAHRs revert to default values. On a branch return (and on return from the interrupt), the elements in the top stack level are copied into the DAHRs, and the elements in the stack are popped up one level, with the elements in the bottom stack level reverting to default values. In one embodiment, on an update to a backing store pointer for a register stack engine (RSE) (mov-to-BSPSTORE) instruction (used for a context switch, but rarely otherwise), which indicates to a general register hardware stack where in memory to spill registers when a hardware stack (that is separate from the hint stack) overflows, all DAHRs and all elements at all levels of the DAHS revert to default values.

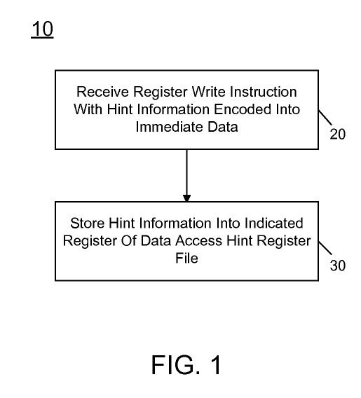

Referring now to FIG. 1, shown is a flow diagram of a method in accordance with an embodiment of the present invention. As shown in FIG. 1, method 10 can be used to store hint information into hint registers. Method 10 may begin by receiving a register write instruction with hint information that is encoded into immediate data associated with the instruction (block 20). For example, processor logic such as an execution unit can receive this register write instruction along with the immediate data. Note that this immediate data may correspond to the actual hint data. Encoding hint information as an immediate allows a code optimizer to insert hints after registers have been allocated by the compiler. Note that “after” could be in a static compiler or some sort of dynamic code optimizer including a just-in-time (JIT) compiler. Instructions can also be provided to write the DAHRs via a move from a general register, in some embodiments.

Still referring to FIG. 1, responsive to this instruction, hint information can be stored into an indicated register of the data access hint register file (block 30). This register write instruction can identify a given register of the hint register file in which the immediate data is to be written as the hint information. In one embodiment, the register write instruction may be a mov-to-DAHR instruction, which copies a set of data access hint fields, encoded within an immediate field in the instruction, into the DAHR. This instruction executes as a no operation (nop) on a processor that does not implement DAHRs, and hence can be used in generic code. Note that the value in a DAHR can be copied to a general purpose register with a mov-from-DAHR instruction. This instruction takes an illegal operation fault on processors that do not implement DAHRs.

In one embodiment, a representative move-to-hint register instruction may take the following form: mov dahr₃=imm₁₆. Responsive to this instruction, the source operand is copied to the destination register. More specifically, the value in imm₁₆ is placed in the DAHR specified by the dahr₃ instruction field.

Note that method 10 is used to write hint values into a given register of the hint register file according to code (e.g., user level or system level). Understand that upon system reset, default values can be loaded into all of the registers of the hint register file. Furthermore, although only a single register write instruction is shown in FIG. 1, understand that multiple such instructions can be present, each of which can be used to store particular information into a given hint register. Also, although the implementation shown in FIG. 1 is used to write values into all fields of a given register, in other implementations the immediate data can be specified to be stored only in certain fields of a given hint register. Other variations are possible, such as a given register write instruction in which immediate data can be written to multiple ones of the hint registers or so forth.

When programming of the hint registers is completed, which may include programming of all the registers, a single register or some number in between, these registers can be accessed during execution of code to optimize some aspect of execution via this hint information stored in the hint registers. Also understand that a software function can program multiple DAHRs at different times. For example, the function can program and access a first of these programmed DAHRs (e.g., with a load instruction), and at a later point in the code program others of the DAHRs.

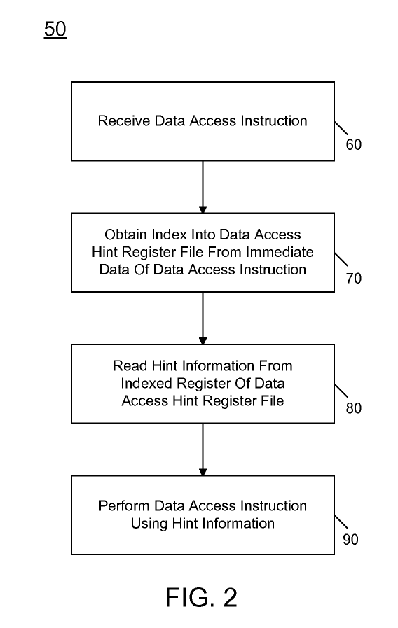

Referring now to FIG. 2, shown is a flow diagram of a method for using hint information in accordance with an embodiment of the present invention. As shown in FIG. 2, method 50 can be implemented in processor logic during execution of instructions. In this specific embodiment shown, the instruction execution may be with regard to data access instructions such as loads, stores or so forth. However, understand the scope of the present invention is not limited in this regard. As seen in FIG. 2, method 50 can begin by receiving a data access instruction (block 60). Assume for purposes of discussion that this data access instruction is an instruction to load data from memory. As is well known, instructions include various fields including an opcode, one or more operands, immediate data and so forth. According to a legacy instruction set architecture (ISA), namely an Intel™ architecture (IA) ISA, a load instruction can include, as its immediate data, a hint as to a type of data handling to be applied to the loaded data. More specifically, legacy instructions can provide a hint value in the immediate data to indicate the temporal locality with respect to the cache line being accessed and accordingly, a given processor can potentially use this information to store the data in a particular cache location to take advantage of certain tendencies of the loaded data.

In various embodiments, rather than encoding hint information into this immediate value of the data access instruction, instead the immediate value can be used to convey an index into the hint register file. Thus the immediate value can be used as an index value to access a particular register of the hint register file, as seen at block 70 of FIG. 2. Accordingly, control passes to block 80 where hint information from this indexed register of the hint register file can be read. Then using this information, the data access instruction can be performed (block 90). For example, in the context of a load instruction, the hint information can indicate that the data has high temporal locality, and accordingly should be stored in a temporal portion of a given level of a cache memory hierarchy. Although shown with this particular implementation in the embodiment of FIG. 2, understand the scope of the present invention is not limited in this regard.

FIG. 2 thus describes a high-level usage of hint information accessing and use during instruction execution. As described above, multiple sets of hint information can be stored in an independent hint or DAHR stack. The different levels of this stack, each corresponding to a set of hint values, can be associated with different functions present in code to be executed.

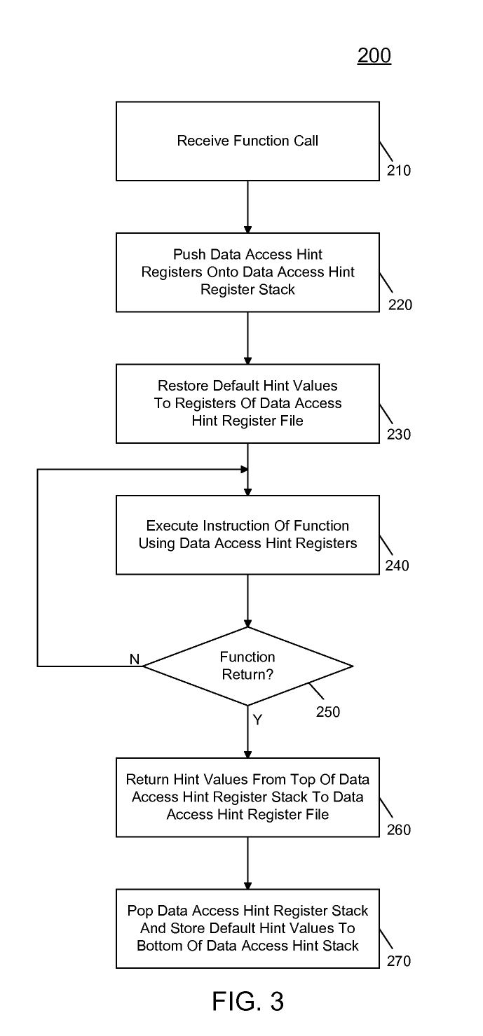

Referring now to FIG. 3, shown is a flow diagram of a method of accessing a hint stack in accordance with an embodiment of the present invention. As shown in FIG. 3, method 200 can be used to perform operations with the hint stack and hint register file in accordance with an embodiment of the present invention. As seen, method 200 begins by receiving a function call (block 210). As part of the operations performed before entering into the function, the data stored in the hint registers can be pushed onto a hint stack (also referred to herein as a DAHR stack) (block 220). In various embodiments, the stack can include a plurality of levels, each to store a set of hint values from the hint register file. Assume for purposes of discussion that the hint register file includes 8 registers. Accordingly, each level of the hint register stack can include 8 storage locations and in such embodiments, the number of levels can also be 8. Of course the scope of the present invention is not limited to these sizes.

Still referring to FIG. 3, after pushing the current hint information from the hint register file onto the hint stack, at block 230 default hint values can be restored to the registers of the hint register file. At this point, execution of instructions of the function can be performed using the hint registers (block 240). Although not shown, understand that some of these instructions can include instructions to write certain hint values into the hint registers to thus overwrite the now present default values. Accordingly, at block 240 instruction execution can occur, and it can be determined at diamond 250 whether a return from the function is to occur. If not, control passes to block 240 above.

On a function return, control passes to block 260 where the hint values can be returned from the top of the hint stack to the registers of the hint register file. Accordingly, the previously stored values from the calling location can be returned such that the hint values usable by this portion of the code are present in the hint register file. As further seen in FIG. 3, control passes to block 270 where the hint register stack can be popped such that each of the levels is moved up a level and the default hint values can be written into the bottom level of the register stack. Although shown with this particular implementation in FIG. 3, understand the scope of the present invention is not limited in this regard.

Thus on a branch call such as to a function, the values in the DAHRs (if implemented) are pushed onto the hint stack, and the DAHRs revert to default values. Similarly, on a return, the values in the DAHRs are copied from the top level of the hint stack, the stack is popped, and the bottom level of the hint stack reverts to default values.

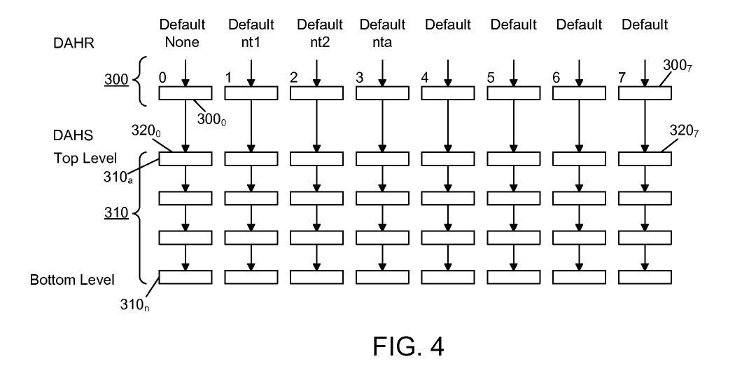

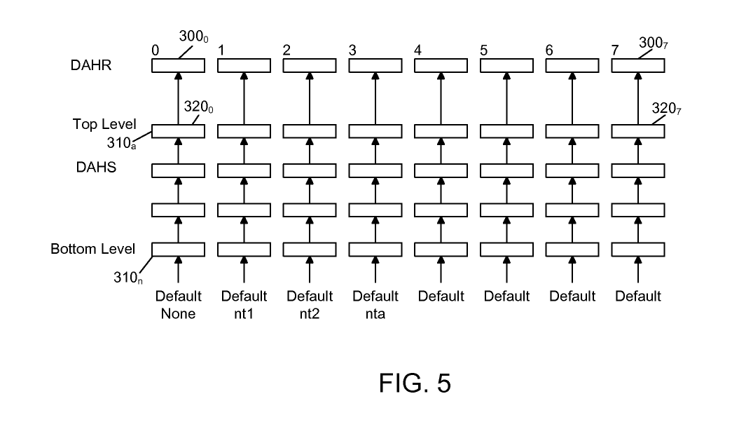

For a graphical illustration of the mechanisms for pushing hint values onto the hint stack and popping values from the hint stack into the hint registers, reference can be made to FIGS. 4 and 5. Specifically, FIG. 4 shows a high-level block diagram of a set of data access hint registers 300₀-300₇ (generally hint registers 300) and a data access hint stack 310 that includes a plurality of levels 310ₐ-310ₙ, each of which includes storage locations 320₀-320₇, each associated with one of the hint registers. In the view shown in FIG. 4, on a call operation, default values are written into hint registers 300 and the values previously stored in hint registers 300 are pushed onto the top level 310₀ of hint stack 310. Accordingly, the values present in the bottom level 310ₙ fall out. Note that although these values are lost, correct program execution is not affected since these hint values provide for optimizations to program execution and do not affect correctness of execution.

FIG. 5 shows essentially the opposite operations, namely on return the values stored in the top level 310ₐ of the stack are restored back to hint registers 300₀-300₇ and the default values can be popped onto bottom level 310ₙ.

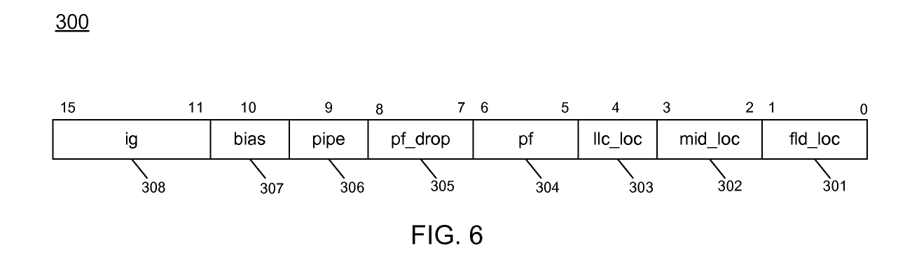

Referring now to FIG. 6, shown is a block diagram of an example hint register format in accordance with an embodiment of the present invention. As shown in FIG. 6, register 300 includes a plurality of fields 301-308. In the embodiment of FIG. 6, the definitions of the different fields may be as in Table 2, below. Understand that although shown in Table 2 with these definitions, different definitions for the fields can occur in other embodiments. And furthermore understand that although shown with 8 fields, embodiments are not so limited and in other implementations greater or fewer number of fields can be present. Furthermore, although a 16-bit register is shown for ease of illustration, register widths of different sizes are possible in other embodiments.

Various specific data access hints can be implemented within DAHRs. In one embodiment, the data access hint register format is as shown in FIG. 6. With reference to FIG. 6, the following Table 2 identifies the 8 different fields present in a DAHR in accordance with an embodiment of the present invention.

TABLE 2

| Field | Bits | Description |
|---|---|---|
| fld_loc | 1:0 | First-level (L1) data cache locality |
| mld_loc | 3:2 | Mid-level (L2) data cache locality |
| llc_loc | 4 | Last-level (L3) data cache locality |
| pf | 6:5 | Data prefetch |
| pf_drop | 8:7 | Data prefetch drop |
| pipe | 9 | Block pipeline vs. background handling |
| | | for lfetch and speculative loads |
| bias | 10 | Bias cache allocation to shared or |
| | | exclusive |
| ig | 15:11 | Writes are ignored; reads return 0 |

The semantics of the hints for these hint fields in accordance with an embodiment of the present invention are described in the following Tables 3-9.

TABLE 3

| Bit Pattern | Name | Description |
|---|---|---|
| 00 | fld_normal | normal cache allocation and fill |
| 01 | fld_nru | mark cache line as not recently used (most |
| | | eligible for replacement), whether the access |
| | | requires an L1 allocation and fill or the access |
| | | hits in the L1 cache |
| 10 | fld_no_allocate | if the access does not hit in the L1 cache, do |
| | | not allocate nor fill into the L1 cache |
| 11 | Unused | |

Table 3 above sets forth field values for a first-level (L1) cache field in accordance with one embodiment of the present invention. Specifically, the hints specified by fld_loc field 301 allow software to specify the locality, or likelihood of data reuse, with regard to the first-level (L1) cache. For example, the fld_nru hint can be used to indicate that the data has some non-temporal (spatial) locality (meaning that adjacent memory objects are likely to be referenced as well) but poor temporal locality (meaning that the referenced data is unlikely to be re-accessed soon). A processor may use this hint by placing the data in a separate non-temporal structure at the first level, if implemented, or by encaching the data in the level 1 cache, but marking the line as eligible for replacement. The fld_no_allocate hint is stronger, indicating that the data is unlikely to have any kind of locality (or likelihood of data reuse), with regard to the level 1 cache. A processor may use this hint by not allocating space at all for the data at level 1. Of course other uses for these and the other hint fields are possible in different embodiments.

TABLE 4

| Bit Pattern | Name | Description |
|---|---|---|
| 00 | mid_normal | normal cache allocation and fill |
| 01 | mid_nru | mark cache line as not recently used (most |
| | | eligible for replacement), whether the access |
| | | requires an L2 allocation and fill or the |
| | | access hits in the L2 cache |
| 10 | mid_no_allocate | if the access does not hit in the L2 cache, do |
| | | not allocate nor fill into the L2 cache |
| 11 | Unused | |

Table 4 above sets forth field values for a mid-level (L2) cache field in accordance with one embodiment of the present invention. Specifically, the hints specified by mld_loc field 302 allow software to specify the locality, or likelihood of data reuse, with regard to the mid-level (L2) cache, similarly to the level 1 cache hints.

TABLE 5

| Bit Pattern | Name | Description |
|---|---|---|
| 0 | Llc_normal | normal cache allocation and fill |
| 0 | llc_nru | mark cache line as not recently used (most |
| | | eligible for replacement), whether the access |
| | | requires an L3 allocation and fill or the access |
| | | hits in the L3 cache |

Table 5 above sets forth field values for a last-level (LLC) cache field in accordance with one embodiment of the present invention. Specifically, the hints specified by llc_loc field 303 allow software to specify the locality, or likelihood of data reuse, with regard to the last-level cache (LLC), similarly to the level 1 and 2 cache hints, except that there is not a no-allocate hint.

TABLE 6

| Bit Pattern | Name | Description |
|---|---|---|
| 00 | pf_normal | normal processor-initiated prefetching |
| | | enabled |
| 01 | pf_no_fld | disable processor-initiated prefetching into |
| | | the first-level (L1) data cache; all other |
| | | processor-initiated prefetching enabled |
| 10 | pf_no_mid | disable processor-initiated prefetching into |
| | | the first-level (L1) data and mid-level (L2) |
| | | caches; all other processor-initiated |
| | | prefetching enabled |
| 11 | pf_none | disable all processor-initiated prefetching |

Table 6 above sets forth field values for a prefetch field in accordance with one embodiment of the present invention. The hints specified by pf field 304 allow software to control any data prefetching that may be initiated by the processor based on this reference. Such automatic data prefetching can be disabled at the first-level cache (pf_no_fld), the mid-level cache (pf_no_mld), or at all cache levels (pf_none).

TABLE 7

| Bit Pattern | Name | Description |
|---|---|---|
| 00 | pfd_normal | normal software-initiated and processor- |
| | | initiated data prefetching |
| 01 | pfd_tlb | an attempted data prefetch is dropped if the |
| | | address misses in the data TLB |
| 10 | pfd_tlb_mid | an attempted data prefetch is dropped if the |
| | | address misses in the data TLB or the mid- |
| | | level (L2) data cache |
| 11 | pfd_any | an attempted data prefetch is dropped if the |
| | | address misses in the data TLB or the mid- |
| | | level (L2) data cache, or if any other events |
| | | occur which would require additional |
| | | execution resources to handle |

Table 7 above sets forth field values for another prefetch field in accordance with an embodiment of the present invention. The hints specified by pf_drop field 305 allow software further control over any software-initiated data prefetching due to this instruction (for the lfetch instruction) or any data prefetching that may be initiated by the processor based on this reference. Rather than disabling prefetching into various levels of cache, as provided by hints in the pf field, hints specified by this field allow software to specify that prefetching should be done, unless the processor determines that such prefetching would require additional execution resources. For example, prefetches may be dropped if it is determined that the virtual address translation needed is not already in a data translation lookaside buffer (TLB) (pfd_tlb); if it is determined that either the translation is not present or the data is not already at least at the mid-level cache level (pfd_tlb_mld); or if these or any other additional execution resources are needed in order to perform the prefetch (pfd_any).

TABLE 8

| Bit Pattern | Name | Description |
|---|---|---|
| 0 | pipe_defer | lfetch instructions that miss in the TLB need |
| | | not block the pipeline, but the virtual |
| | | hardware page table (VHPT) walker may fill |
| | | their TLB translations in the background, |
| | | while the pipeline continues; speculative |
| | | loads may be spontaneously deferred on a |
| | | TLB miss or a mid-level data (MLD) cache |
| | | miss |
| 1 | pipe_block | lfetch instructions block the pipeline until |
| | | they are done fetching their TLB translations; |
| | | speculative loads are not spontaneously |
| | | deferred and block uses of their target |
| | | registers until they have completed |

Table 8 above sets forth example values for further prefetch hint values in accordance with an embodiment of the present invention. The hints specified by pipe field 306 allow software to specify how likely or soon it is to need the data specified by an lfetch instruction or a speculative load instruction. The pipe_defer hint indicates that the data should be prefetched as soon as possible (lfetch instruction) or copied into the target general register (speculative load instruction) if it would not be very disruptive to the execution pipeline to do so. If this data movement might delay the pipeline execution of subsequent instructions (for example, due to TLB or mid-level cache misses), the instruction is instead executed in the background, allowing the pipeline to continue executing subsequent instructions. For speculative load instructions, if this background execution would take significantly extra time, the processor may spontaneously defer the speculative load, as allowed by a given recovery model.

The pipe_block hint indicates that the data should be prefetched as soon as possible (lfetch instruction) or copied into the target general register (speculative load instruction) independent of whether this might delay the pipeline execution of subsequent instructions. For speculative load instructions, no spontaneous deferral is done.

TABLE 9

| Bit Pattern | Name | Description |
|---|---|---|
| 0 | bias_excl | if the processor has a choice of getting a line |
| | | in either the shared or exclusive MESI states, |
| | | choose exclusive |
| 1 | bias_shared | if the processor has a choice of getting a line |
| | | in either the shared or exclusive MESI states, |
| | | choose shared |

Table 9 above sets forth hint values for a cache coherency hint field in accordance with one embodiment of the present invention. The hints specified by bias field 307 allow software to optimize cache coherence activities. For load instructions and lfetch instructions, if the referenced line is not already present in the processor's cache, and if the processor can encache the data in either the shared or the modified status of a modified exclusive shared invalid (MESI) protocol, the bias_excl hint indicates that the processor should encache the data in the exclusive state, while the bias_shared hint indicates that the processor should encache the data in the shared state.

Embodiments may be implemented in instructions for execution by a processor, including instructions of a given ISA. These instructions can include both specific instructions such as the instructions described above to store values in to hint registers, as well as instructions that index into a given hint register of the hint register file to obtain hint information for use in connection with instruction execution.

As an example, processor logic can receive a first instruction such as a given register write instruction that includes an identifier of a first hint register of the hint register file and further includes a first value to be stored into the register (which can be provided as an immediate data of the instruction). Responsive to this instruction, the logic can store the first value in the first hint register. This first value may include individual values each corresponding to a hint field of the first hint register.

After this programming of the hint register, the logic can receive a second instruction to perform an operation according to an opcode of the instruction. Note that this instruction may have a data portion (such as an immediate data field) to index the first hint register of the hint register file. Then the operation can be performed according to at least one of the individual values stored in the first hint register. In this way, optimization of the operation can occur using this hint information.

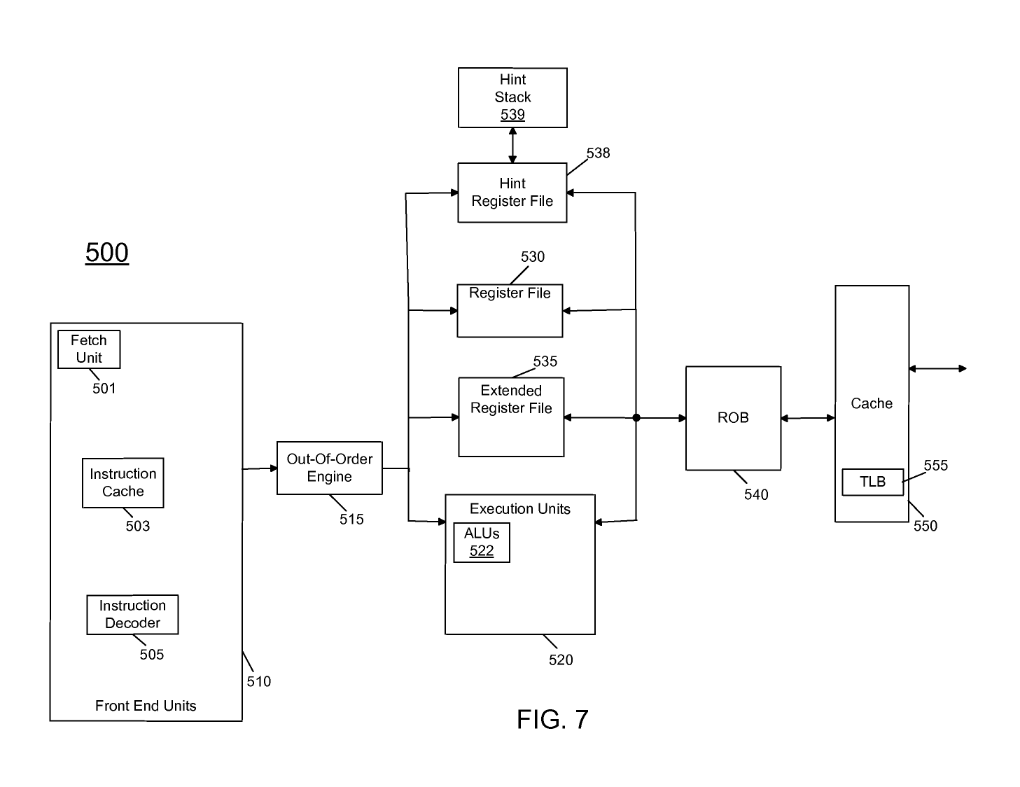

Embodiments can be implemented in many different processor types. For example, embodiments can be realized in a processor such as a single core or multicore processor. Referring now to FIG. 7, shown is a block diagram of a processor core in accordance with one embodiment of the present invention. As shown in FIG. 7, processor core 500 may be a multi-stage pipelined out-of-order processor. Processor core 500 is shown with a relatively simplified view in FIG. 7 to illustrate various features used in connection with hint registers in accordance with an embodiment of the present invention. Note that although shown in connection with an out-of-order processor, understand the scope of the present invention is not limited in this regard, and embodiments can equally be used with an in-order processor.

As shown in FIG. 7, core 500 includes a front end unit 510, which may be used to fetch instructions to be executed and prepare them for use later in the processor. For example, front end unit 510 may include a fetch unit 501, an instruction cache 503, and an instruction decoder 505. In some implementations, front end unit 510 may further include a trace cache, along with microcode storage as well as a micro-operation storage. Fetch unit 501 may fetch macro-instructions, e.g., from memory or instruction cache 503, and feed them to instruction decoder 505 to decode them into primitives such as micro-operations for execution by the processor.

Coupled between front end unit 510 and execution units 520 is an out-of-order (OOO) engine 515 that may be used to receive the micro-instructions and prepare them for execution. More specifically OOO engine 515 may include various buffers to re-order micro-instruction flow and allocate various resources needed for execution, as well as to provide renaming of logical registers onto storage locations within various register files such as register file 530 and extended register file 535. Register file 530 may include separate register files for integer and floating point operations. Extended register file 535 may provide storage for vector-sized units, e.g., 256 or 512 bits per register. As further seen, a hint register file 538 may be present that includes a plurality of registers, e.g., having the field structure shown in FIG. 6, to store hint information for use in execution of data access and/or other instructions.

Various resources may be present in execution units 520, including, for example, various integer, floating point, and single instruction multiple data (SIMD) logic units, among other specialized hardware. For example, such execution units may include one or more arithmetic logic units (ALUs) 522.

When operations are performed on data within the execution unit, results may be provided to retirement logic, namely a reorder buffer (ROB) 540. More specifically, ROB 540 may include various arrays and logic to receive information associated with instructions that are executed. This information is then examined by ROB 540 to determine whether the instructions can be validly retired and result data committed to the architectural state of the processor, or whether one or more exceptions occurred that prevent a proper retirement of the instructions. Of course, ROB 540 may handle other operations associated with retirement.

As shown in FIG. 7, ROB 540 is coupled to cache 550 which, in one embodiment may be a first level cache (e.g., an L1 cache) and which may also include TLB 555, although the scope of the present invention is not limited in this regard. From cache 550, data communication may occur with higher level caches, system memory and so forth. To provide for in-processor backup storage for hint information, a hint stack 539 may be present, which as seen can be closely coupled with hint register file 538.

Note that while the implementation of the processor of FIG. 7 is with regard to an out-of-order machine such as of a so-called x86 ISA architecture, the scope of the present invention is not limited in this regard. That is, other embodiments may be implemented in an in-order processor such as an Intel ITANIUM™ processor, a reduced instruction set computing (RISC) processor such as an ARM-based processor, or a processor of another type of ISA that can emulate instructions and operations of a different ISA via an emulation engine and associated logic circuitry.

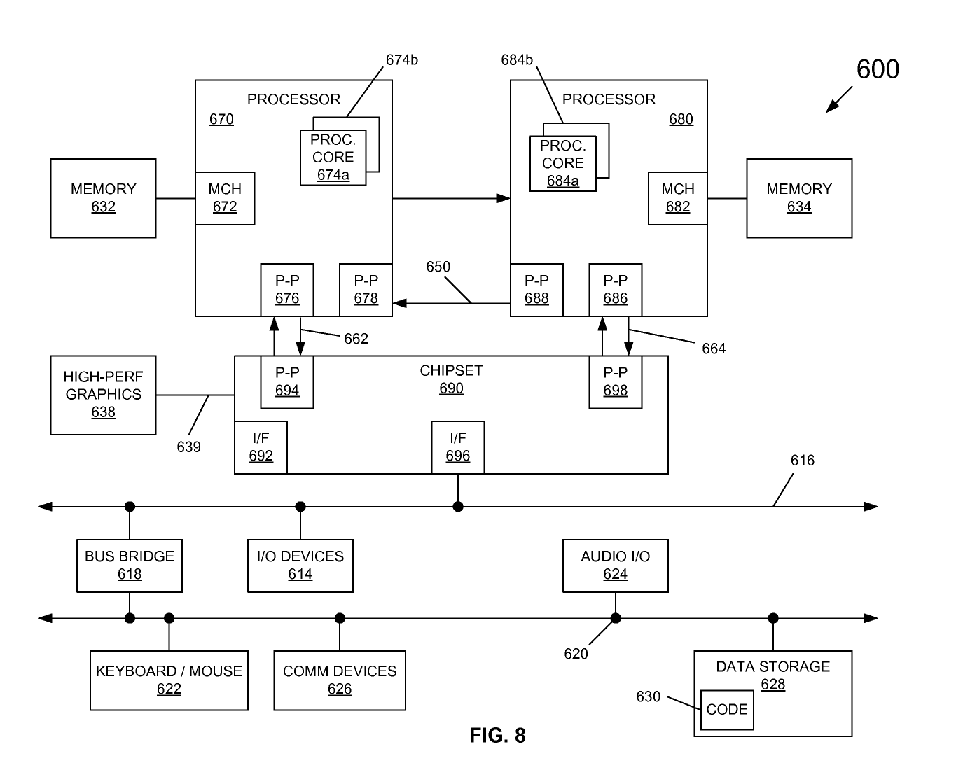

Embodiments may be implemented in many different system types. Referring now to FIG. 8, shown is a block diagram of a system in accordance with an embodiment of the present invention. As shown in FIG. 8, multiprocessor system 600 is a point-to-point interconnect system, and includes a first processor 670 and a second processor 680 coupled via a point-to-point interconnect 650. As shown in FIG. 8, each of processors 670 and 680 may be multicore processors, including first and second processor cores (i.e., processor cores 674a and 674b and processor cores 684a and 684b), although potentially many more cores may be present in the processors. Each of the processors can include a hint register file and possibly a hint stack, which can be used by logic to perform instructions using extended hint information present in these structures, as described herein.

Still referring to FIG. 8, first processor 670 further includes a memory controller hub (MCH) 672 and point-to-point (P-P) interfaces 676 and 678. Similarly, second processor 680 includes a MCH 682 and P-P interfaces 686 and 688. As shown in FIG. 8, MCH's 672 and 682 couple the processors to respective memories, namely a memory 632 and a memory 634, which may be portions of system memory (e.g., DRAM) locally attached to the respective processors. First processor 670 and second processor 680 may be coupled to a chipset 690 via P-P interconnects 652 and 654, respectively. As shown in FIG. 8, chipset 690 includes P-P interfaces 694 and 698.

Furthermore, chipset 690 includes an interface 692 to couple chipset 690 with a high performance graphics engine 638, by a P-P interconnect 639. In turn, chipset 690 may be coupled to a first bus 616 via an interface 696. As shown in FIG. 8, various input/output (I/O) devices 614 may be coupled to first bus 616, along with a bus bridge 618 which couples first bus 616 to a second bus 620. Various devices may be coupled to second bus 620 including, for example, a keyboard/mouse 622, communication devices 626 and a data storage unit 628 such as a disk drive or other mass storage device which may include code 630, in one embodiment. Further, an audio I/O 624 may be coupled to second bus 620. Embodiments can be incorporated into other types of systems including mobile devices such as a smartphone, tablet computer, ultrabook, netbook, or so forth.

Embodiments may be implemented in code and may be stored on a non-transitory storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor comprising:
at least one execution unit to execute instructions;
a register file having a first plurality of registers each to store an operand for use in execution of an instruction; and
a hint register file having a second plurality of registers each to store a set of fields each to store a hint value for use by a logic of the processor.

2. The processor of claim 1, wherein the at least one execution unit is to access one of the second plurality of registers based on an immediate value of an instruction.

3. The processor of claim 2, wherein the immediate value corresponds to an index value into the hint register file.

4. The processor of claim 2, wherein the processor is to execute a data access instruction using a hint value present in the accessed one of the second plurality of registers.

5. The processor of claim 1, further comprising a hint stack to store a plurality of sets of hint value collections, each set associated with a function.

6. The processor of claim 5, wherein the processor is to store one of the plurality of sets of hint value collections into the hint stack responsive to a call to a first function.

7. The processor of claim 6, wherein the processor is to load default hint values into the hint register file responsive to the call to the first function.

8. The processor of claim 6, wherein the processor is to load the one of the plurality of sets of hint value collections from the hint stack to the hint register file responsive to a return from the first function.

9. The processor of claim 1, wherein the processor is to execute a register write instruction to store hint information into one of the second plurality of registers.

10. The processor of claim 9, wherein the hint information is encoded as an immediate value associated with the register write instruction.

11. A method comprising:
receiving a data access instruction in a logic of a processor and obtaining an index into a data access hint register (DAHR) register file of the processor from the data access instruction, the DAHR register file including a plurality of data access hint registers;
reading hint information from a data access hint register of the DAHR register file accessed using the index; and
performing the data access instruction using the hint information.

12. The method of claim 11, further comprising receiving a register write instruction having first hint information encoded into immediate data associated with the register write instruction.

13. The method of claim 12, further comprising storing the first hint information into a first data access hint register of the DAHR register file responsive to the register write instruction.

14. The method of claim 11, further comprising storing data requested by the data access instruction into a temporal portion of a first cache memory of the processor responsive to the data access instruction and the hint information.

15. The method of claim 11, wherein the index corresponds to an immediate value associated with the data access instruction.

16. The method of claim 15, wherein the immediate value corresponds to a legacy hint value, and reading the hint information from the accessed register of the DAHR register file to obtain the legacy hint value.

17. The method of claim 11, further comprising storing hint information in the plurality of data access hint registers into a hint stack of the processor responsive to a function call.

18. The method of claim 17, further comprising thereafter storing default hint information into the plurality of data access hint registers.

19. A system comprising:
a processor including a logic to receive a first instruction including an immediate data and to access at least one hint field of a first hint register of a hint register file using the immediate data, wherein the logic is to optimize execution of the first instruction according to a value of the at least one hint field, the processor further including the hint register file and a general purpose register file including a plurality of registers each to store an operand for an instruction; and
a dynamic random access memory (DRAM) coupled to the processor.

20. The system of claim 19, wherein the processor further comprises a hint stack to store a plurality of sets of hint value collections, each set associated with a function.

21. The system of claim 19, wherein the processor is to store data obtained via a data access instruction in a temporal portion of a selected level of a cache memory of the processor responsive to a value of a first hint field of the first hint register.

22. The system of claim 21, wherein the processor is to store the data obtained via the data access instruction with a selected cache coherency state responsive to a value of a second hint field of the first hint register.

23. The system of claim 19, wherein the processor is to access the first hint register including default hint values responsive to an instruction of legacy code that includes an immediate value corresponding to a first hint value.

24. The system of claim 23, wherein the first hint value is stored in a hint field of the first hint register, the first hint register indexed by the immediate value.

25. The system of claim 19, wherein the processor is to prevent prefetching of data to be obtained by a data access instruction responsive to a value of a third hint field of the first hint register.

26. A machine-readable storage medium having stored thereon instructions, which if performed by a machine cause the machine to perform a method comprising:
receiving a first instruction of an instruction set architecture (ISA), the first instruction including an identifier of a first hint register of a hint register file of a processor and further including a first value; and
storing the first value in the first hint register responsive to the first instruction, the first value including a plurality of individual values each corresponding to a hint field of the first hint register.

27. The machine-readable storage medium of claim 26, wherein the method further comprises:
receiving a second instruction of the ISA, the second instruction to perform an operation according to an opcode of the second instruction, the second instruction having a data portion to index the first hint register of the hint register file.

28. The machine-readable storage medium of claim 27, wherein the method further comprises performing the operation according to at least one of the individual values stored in the first hint register.

29. The machine-readable storage medium of claim 27, wherein the first value comprises an immediate data of the first instruction, and the data portion of the second instruction comprises an immediate data of the second instruction.
